(19) United States
(12) Patent Application Publication
(10) Pub. No.: US 2012/0315034 A1
(43) Pub. Date: Dec. 13, 2012

(54) Detector And Method Thereof

(75) Inventors: Chang-Hung Tien, Taoyuan County (TW); San-Ching Kuo, Taoyuan County (TW)

(73) Assignee: Delta Networks, Inc., Taoyuan County (TW)

(21) Appl. No.: 13/491,539

(22) Filed: Jun. 7, 2012

(30) Foreign Application Priority Data
Jun. 8, 2011 (TW) 100120054

(51) Int. Cl. H04B 10/08; H04B 10/20

(52) U.S. Cl. 398/35

(57) ABSTRACT

This invention provides a detecting device and a method for a passive optical network (PON), which includes: a laser device; a detector coupled to the laser device and generating an output signal at one of a first level when the laser device emits light and a second level when the laser device does not emit light; and a processor repeatedly detecting the output signal in a fixed period, and simultaneously counting a total number of changes that the output signal changes from the first level to the second level and the output signal changes from the second level to the first level so as to detect whether a light leakage occurs in the PON.

### CROSS-REFERENCE TO RELATED APPLICATION

The present invention claims the benefits of priority from the Taiwanese Patent Application No. 100120054, filed on Jun. 8, 2011, the contents of the specification of which are hereby incorporated herein by reference.

### FIELD OF THE INVENTION

This invention relates to a detecting device and a method thereof, particularly relates to a detecting device for detecting the condition that light leakage is occurring in a passive optical network (PON) and a method thereof.

### BACKGROUND OF THE INVENTION

Regardless of the ADSL or the optical communication networks in the traditional framework of the network, all of them belong to a point-to-point framework, i.e., the system terminal (the engine room) to the customer premises equipment (CPE), for example, the line from the engine room of the ADSL to the home of the customer. In order to reduce the cost and to implement more applications, a type of framework termed as passive optical networks (PON) is developed in the optical networks, which supports 1-to-32 to 1-to-64 clients according to the ability of the central office (CO). In the past, the xDSL family is denounced for that the distance between the engine room and the customer terminal is about 150 meters. However, the distance between the CO terminal and the CPE terminal in the optical network is about 20 kilometers. Thus, the range within a radius of 20 kilometers of the CO can be covered by the tree style framework of the PON.

FIG. 1(a) and FIG. 1(b) are diagrams showing the downstream and the upstream in an ordinary PON framework.

Firstly, please referring to FIG. 1(a), the laser signal in the downstream, i.e., the CO terminal to the CPE terminal, is emitted in continuous mode, which is a continuous signal. The optical line terminal 11 at the system terminal processes the transmissions by time-division multiplexing (TDM) broadcasting, sends the packet A, packet B and packet C through the optical splitter 15 to the optical network terminals (ONT) 12, 13 and 14 at the customer terminal. Under such a framework, a transmission rate of 1.25 Gbit/sec can be reached in practice.

Please go on referring to FIG. 1(b), the upstream in the PON uses the time-division multiple access (TDMA) technique. The ONTs 12, 13 and 14 at the CPE terminal upload packets to the CO terminal according to a fixed timing range arranged by the OLT 11 at the CO terminal. Each packet from ONT is separated by a time gap of 25.6 nano seconds from one another.

However, the PON has a critical defect. If an unusual phenomenon occurs at a certain CPE, such as the CPE damaging, the unusual light signal acting, laser leakage, continuous light emitting or malicious attacks (such as connecting an optical fiber where light is emitted in continuous mode), such that the CPE emits light continuously, such CPEs are usually called rogue CPEs. Since the PON belongs to a passive network framework, the CO terminal receives the signals being continuous in time sequence from such CPE. Therefore, the time sequences for the other CPEs are occupied, such that the operations and use of the other CPE are heavily affected. The worst case is that all the other CPEs are affected and the system is heavily down. Not only inconvenience is caused, but also the information security is threatened. Also, in the present days, the cloud applications are becoming a trend, and the optical networks must be getting popular. Therefore, it is an important issue that how to quickly and effectively find out the unusual CPE.

The general solution at present is that when there are unusual actions of light signals or laser leakage occurring at the upstream, bisection method is applied at the CO terminal for finding out the unusual CPE. Taking a 1-to-64 PON network for example, each of the linked CPE is shut down and reboot first, and then half (for example, the odd number CPEs) of all the CPEs are shut down. If there is still unusual condition occurring, then it means that the unusual CPE to be found out exists in the CPEs not being shut down. Then, apply the same method to the CPEs not being shut down in order to process the search, and repeat such steps until the unusual CPE is found.

Therefore, under the worst case, it needs to search six times (since 2⁶=64) to find out the unusual CPE. Because the time spent by the rebooting at the CPE terminal always needs more than 10 seconds, the whole process of unusual condition detecting needs to cost quite a long time. Also, such a method is established under the precondition that the operations of the receivers at the CPE are normal. Under the condition that the CPE is crash or can not work normally, the CPE can not receive the downstream command such that the CO terminal can not use the downstream command to shut the CPE down and the only way is sending the engineers to there to shut the CPE down. Accordingly, it is inconvenient for system maintaining.

It is therefore attempted by the applicant to deal with the above situation encountered in the prior art.

### SUMMARY OF THE INVENTION

The present invention provides a detecting device and a detecting method thereof such that if there is an unusual condition of light leakage occurring at the CPE device, it can be auto detected quickly by the CPE terminal and the CPE device can be shut down automatically.

The CPE can optionally achieve the function of automatically resetting or rebooting when detecting an unusual condition by designing the firmware thereof in order to remove the software problems. In cooperation with the firmware designing or upgrading at the CO terminal, a function of the CPE automatically reporting back when the unusual condition occurring can be further implemented. Accordingly, the CO terminal knows which CPE the unusual condition occurs at, and notifies the engineers to solve the CPE hardware trouble.

In accordance with the first aspect of the present invention, a detecting device for a passive optical network (PON) is provided. The detecting device includes: a laser device; a detector coupled to the laser device and generating an output signal at one of a first level when the laser device emits light and a second level when the laser device does not emit light; and a processor repeatedly detecting the output signal in a fixed period, and simultaneously counting a total number of changes that the output signal changes from the first level to the second level and the output signal changes from the second level to the first level so as to detect whether a light leakage occurs in the PON.

Preferably, the processor detects if the level of the output signal is always kept at the first level in the fixed period and the total number of changes is zero in the fixed period.

Preferably, the processor includes: an analog-to-digital converter (ADC) detecting the output signal; and a timer counting the total number of changes.

Preferably, the laser device is a bi-directional optical sub assembly (BOSA), the BOSA includes a laser diode (LD) and a monitor photo diode (MPD), and the MPD is in one of two states of being conductive and being nonconductive corresponding to respectively when the LD emits light and when the LD does not emit light.

Preferably, the detector includes an operational amplifier having an inverting input terminal and a non-inverting input terminal, and coupled to the MPD, the inverting input terminal is coupled to the MPD through a first resistor and a second resistor, the non-inverting input terminal is coupled to the MPD through a third resistor, and is coupled to the inverting input terminal through a fourth resistor and a fifth resistor, and a node between the fourth and the fifth resistors receives a power supply voltage.

Preferably, the second resistor has a resistance larger than that of the third resistor.

Preferably, the fourth resistor has a resistance equal to that of the fifth resistor, and the operational amplifier further includes an output terminal outputting the output signal, the output signal is at the first level under the condition that the MPD is on, and the output signal is at the second level under the condition that the MPD is off.

Preferably, the detector includes an operational amplifier and is coupled to the LD, wherein the operational amplifier has receiving a laser turn on voltage through a sixth resistor and connected a ground through a seventh resistor.

Preferably, the operational amplifier further includes an output terminal to output the output signal, the output signal is at the first level under the condition that the LD is on, and the output signal is at the second level under the condition that the LD is off.

In accordance with the second aspect of the present invention, a detecting method for a passive optical network (PON) is provided. The method includes steps of: providing a laser device; generating an output signal at one of a first level when the laser device emits light and a second level when the laser device does not emit light; and repeatedly detecting the output signal in a fixed period, and simultaneously counting a total number of changes that the output signal changes from one of the first level and the second level to the other one of the first level and the second level so as to detect whether a light leakage occurs in the PON.

Preferably, the detecting step detects if the level of the output signal is always kept at the first level in the fixed period and the total number of changes is zero in the fixed period.

Preferably, the repeatedly detecting step further includes a step of using a processor to repeatedly detect the output signal, wherein the processor includes: an analog-to-digital converter (ADC) detecting the output signal; and a timer counting the total number of changes.

Preferably, the laser device is a bi-directional optical sub assembly (BOSA), the BOSA includes a laser diode (LD) and a monitor photo diode (MPD), and the MPD is in one of two states of being conductive and being nonconductive corresponding to respectively when the LD emits light and when the LD does not emit light.

Preferably, the generating step is performed by a detector, the detector includes an operational amplifier having an inverting input terminal and a non-inverting input terminal, and coupled to the MPD, the inverting input terminal is coupled to the MPD through a first resistor and a second resistor, the non-inverting input terminal is coupled to the MPD through a third resistor, and is coupled to the inverting input terminal through a fourth resistor and a fifth resistor, and a node between the fourth and the fifth resistors receives a power supply voltage.

Preferably, the second resistor has a resistance larger than that of the third resistor.

Preferably, the fourth resistor has a resistance equal to that of the fifth resistor, and the operational amplifier further includes an output terminal outputting the output signal, the output signal is at the first level under the condition that the MPD is on, and the output signal is at the second level under the condition that the MPD is off.

Preferably, the generating step is performed by a detector, the detector includes an operational amplifier and is coupled to the LD, wherein the operational amplifier has an inverting input terminal receiving a laser turn on voltage through a sixth resistor and connected a ground through a seventh resistor.

Preferably, the operational amplifier further includes an output terminal to output the output signal, the output signal is at the first level under the condition that the LD is on, and the output signal is at the second level under the condition that the LD is off.

In accordance with the third aspect of the present invention, a method for detecting a light leakage in a passive optical network (PON) having a light emitting state and a light non-emitting state is provided. The method includes steps of: repeatedly detecting a plurality of signals transmitted in the PON in a period, wherein the plurality of signals are representative of the light emitting state and the light non-emitting state; and if one of two statuses being that a light non-emitting state is detected and that there is a change occurred between the light emitting state and the light non-emitting state, determining that there is no light leakage.

Preferably, the detecting method further includes a step of: if the detected states are all light-emitting states and there is no change occurred between the light emitting state and the light non-emitting state, determining proving the light leakage is occurring.

### BRIEF DESCRIPTION OF THE DRAWINGS

The foregoing and other features and advantages of the present invention will be more clearly understood through the following descriptions with reference to the drawings, wherein:

FIG. 1(a) and FIG. 1(b) show the framework of the PON in the prior art;

FIG. 2 shows a diagram of a preferable embodiment of the present invention;

FIG. 3 shows a diagram of another preferable embodiment of the present invention; and

FIG. 4 shows a flowchart of a method embodiment of the present invention.

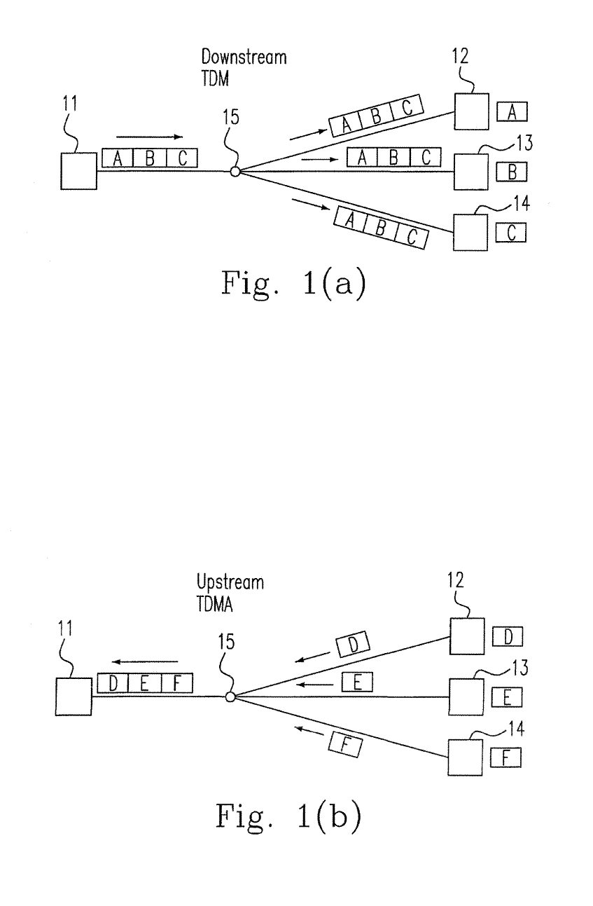

### DETAIL DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

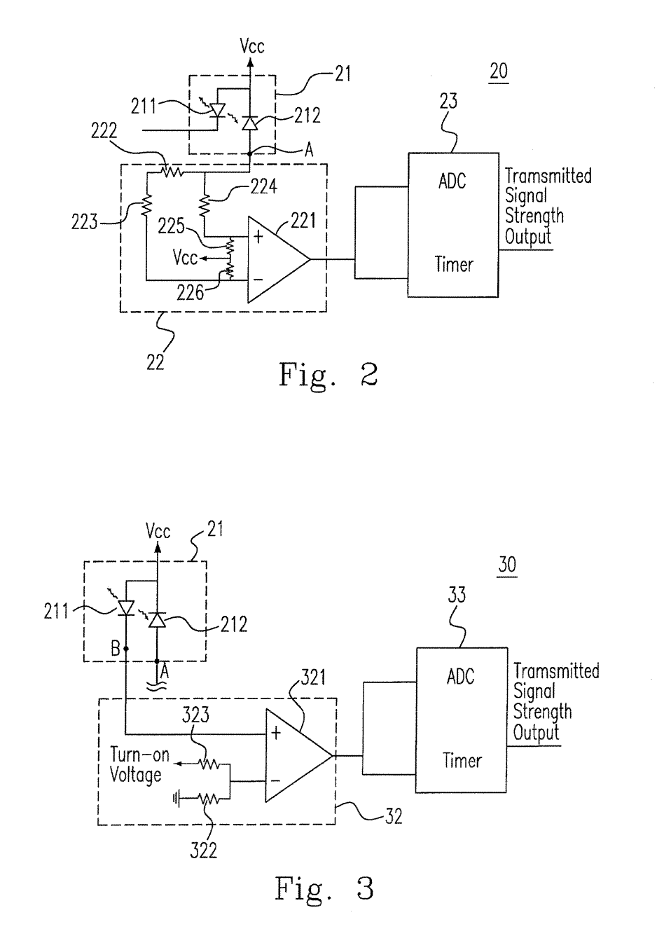

Please referring to FIG. 2, which is a device embodiment of the present invention. The detecting device 20 in FIG. 2 includes a laser device 21, a detector 22 and a processor 23, wherein the detector 22 is coupled to the laser device 21, and the processor 23 is coupled to the detector 22.

Generally speaking, the laser device 21 is a bi-directional optical sub assembly (BOSA) commonly used at the customer terminal in the optical network. The BOSA includes a laser diode (LD) 211 and a monitor photo diode (MPD) 212. The LD 211 is an analog element, whose property would change along with the external environment, such as the temperature. Therefore, the property of the LD 211 needs to be properly compensated and maintained through the MPD 212 detecting. The laser device 21 transmits a light emitting signal representing “1” or a light non-emitting signal representing “0” by the 211 emitting light or not. 90% of the laser emitted by the LD 211 enter the optical fiber lines and become the signals transmitted in the optical network. The MPD 212 receives the remained 10% laser, and is conductive corresponding to the LD 211 emitting light or is nonconductive corresponding to the LD 211 not emitting light in order for adjusting and controlling the laser and controlling the efficiency of the LD 211.

In this embodiment, the BOSA is controlled by an open loop. The pin A of the MPD 212 is not used for connecting additional device for controlling LD 211, and thus the detecting device 22 is coupled to the pin A.

The detector 22 includes an operational amplifier 221, a first resistor 222, a second resistor 223 and a third resistor 224, wherein the second 223 has a resistance a little larger than that of the third resistor 224. The operational amplifier 221 has an inverting input terminal coupled to the MPD 212 through the first resistor 22 and the second resistor 223. The operational amplifier 221 has a non-inverting input terminal coupled to the MPD 212 through the third resistor 224, and the non-inverting input terminal is coupled to the inverting input terminal through the fourth resistor 225 and the fifth resistor 226. The fourth resistor 225 has a resistance equal to that of the fifth resistor 226, and the node between the fourth resistor 225 and the fifth resistor 226 receives a power supply voltage.

The operational amplifier 221 further includes an output terminal to generate an output signal. Under the condition that the MPD 212 is conductive, the current of the MPD 212 passes through the first resistor 222, the second resistor 223 and the third resistor 224, and enters the operational amplifier 221 such that the output signal is at the first level. The detector 22 correspondingly outputs the signal at the first level in response to the laser device emitting. In this embodiment, the first level is preferably a high level (for example, “1”). Under the condition that the MPD 212 is not conductive, the output signal is at the second level. The detector 22 correspondingly outputs the signal at the second level in response to the laser device not emitting. In this embodiment, the second level is preferably a low level (for example, “0”).

The processor 23 includes an analog to digital converter (ADC) and a timer. The ADC is used for repeatedly detecting the output signal of the operational amplifier 221 being at the first level or at the second level in a fixed period. The processor 23 can determine the detecting frequency, such as once per 100 micro seconds, and of course, the detecting frequency can be configured and adjusted by the user.

The timer counts a total number of changes that the output signal of the detector 22 changes from the first level to the second level and the output signal changes from the second level to the first level (i.e., a total number of changes that the output signal changes from one of the first level and the second level to the other one of the first level and the second level).

If the output signal is detected at the first level by the ADC in the fixed period and the total number of changes counted by the timer is zero, then it means that the first level is kept for a certain period of time, which means the LD 211 has emitted light for a period of time. The keeping time allowable for the high level is stipulated in the standard of the network. Since the high level represents for that the laser is emitted in the optical network, it represents for that the light leakage is occurring if the high level is kept for a time period exceeding the allowed keeping time. The processor 23 will accordingly output “1” at the terminal, transmitted signal strength index.

Since sometimes the power of the light leakage is not so large, it is preferable to use a more sensitive (i.e., higher gain) operational amplifier, which has higher bias resistors to prevent from making a wrong judgement due to weak current and guarantee that the output of the operational amplifier is at the “0” level when the LD 211 does not emit light.

Please referring to FIG. 3, which is another embodiment of the present invention. The difference between this embodiment and the previous one is that the BOSA is controlled by a close loop. The pin A of the MPD 212 is connected to the LDD driver (which is a well-known device in the prior art and thus is not shown in this figure) to control the LD 211. Therefore, the design in this embodiment with the close loop is different from that in the previous one with the open loop in order for preventing the close loop being influenced by the external resistor(s). In this embodiment, the detector turns to detect the turn on voltage of the laser, and the subsequent framework for determining the light leakage is similar to that of the previous embodiment.

Under the control by the abovementioned close loop, the pin A of the MPD 212 is connected to the LDD driver to control the LD 211. If the detecting device of the present invention is connected to the pin A of the MPD 212, that would influence the quality that the LLD driver adjusts and controls the LD 211. Therefore, this embodiment uses the pin B of the LD 211, and turns to detect the turn on voltage of the LD211. The detailed embodiment is as follows.

As shown in FIG. 3, the detecting device 30 includes the laser device 21, the detector 32 and the processor 33, wherein the detector 32 is coupled to the laser device 21, and the processor 33 is coupled to the detector 32.

The detector 32 includes the operational amplifier 321, the sixth resistor 322 and the seventh resistor 323, and the detector 32 is coupled to the pin B of the LD 211 through the non-inverting input terminal of the operational amplifier 321. The non-inverting input terminal of the operational amplifier 321 receives the turn on voltage of the laser through the sixth resistor 323, and is connected to the ground through the seventh resistor 322. The resistances of the sixth resistor 323 and the resistor 322 are designed to make the voltage drop across the resistor 323 equal to the voltage drop across the conductive LD 211. Therefore, under the condition that the LD 211 emits light, the output terminal of the operational amplifier 321 would accordingly output an output signal at a first level, wherein the first level is preferably a high level (for example, “1”). Under the condition that the LD 211 does not emit light, the output terminal of the operational amplifier 321 would accordingly output an output signal at a second level, wherein the second level is preferably a low level (for example, “0”).

The processor 33 includes the ADC and the timer. Similar to the previous embodiment, if the output signal is detected at the first level by the ADC in the fixed period and the total number of changes counted by the timer is zero, then it means that the first level is kept for a certain period of time, which means the LD 211 has emitted light for a period of time. The keeping time allowable for the high level is stipulated in the standard of the network. If the high level is kept for a time period exceeding the allowed keeping time, it represents for that the light leakage is occurring. The processor 23 will accordingly output “1” at the terminal, transmitted signal strength index.

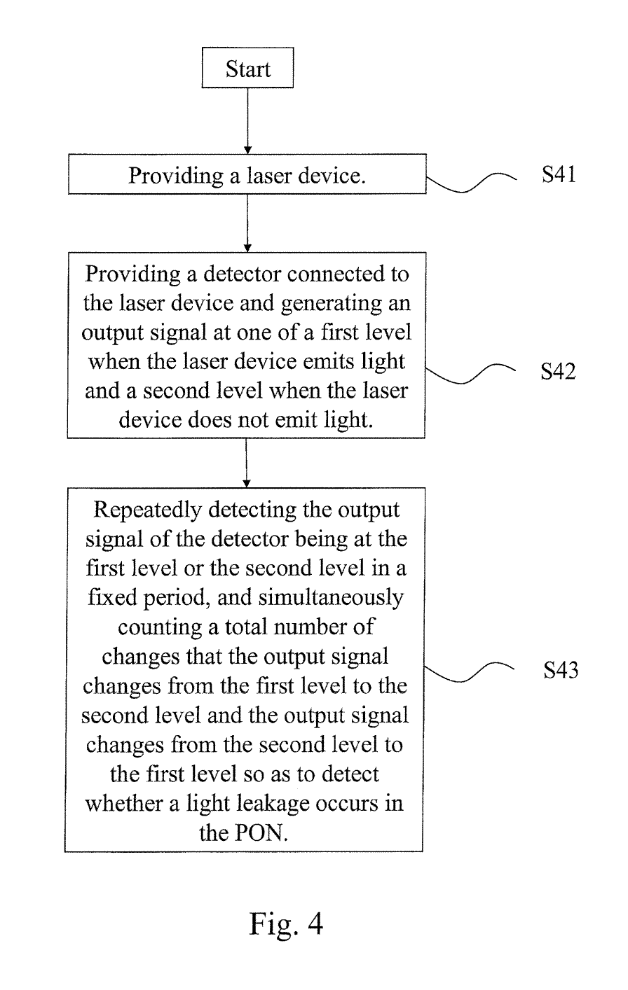

Please referring to FIG. 4, which is a flowchart corresponding to a method embodiment of the present invention. The detecting method provided in the present invention includes the following steps.

Step S41: providing a laser device, which is preferably a BOSA commonly used in a PON network framework as described in the previous embodiments.

Step S42: providing a detector connected to the laser device and generating an output signal at one of a first level when the laser device emits light and a second level when the laser device does not emit light, wherein the detector is preferably coupled to the laser device as described in the previous embodiments. However, it could understood by one skilled in the art that the coupling method is not limited to those provided in the previous embodiments as long as the detector can output an output signal at one of a first level when the laser device emits light and a second level when the laser device does not emit light.

Step S43: repeatedly detecting the output signal of the detector being at the first level or the second level in a fixed period, and simultaneously counting a total number of changes that the output signal changes from the first level to the second level and the output signal changes from the second level to the first level so as to detect whether a light leakage occurs in the PON.

As described in the previous embodiments, a processor including an ADC and a timer or the device with firmware having the equivalent function can be applied to repeatedly detect the output signal being at the first level or the second level in a fixed period, and count a total number of changes that the output signal changes from the first level to the second level and the output signal changes from the second level to the first level. If the detected output signal is always at the first level the ADC in the fixed period and the total number of changes counted by the timer is zero, then it is determined that the light leakage is occurring at the laser device.

The time period occupied by a bit stipulated in the PON framework is 0.8 ns. Therefore, if it is desired to achieve real-time detecting each bit to determine whether there is light leakage in the device, then an operational amplifier with a considerable large size and high cost is needed to be applied. The present invention provides a detecting device using an ordinary high speed operational amplifier repeatedly detecting the output signal corresponding to the laser device emitting or not, and detecting the level changing of the output signal so as to determine whether a light leakage occurs at the laser device. The drawback of using the operational amplifier with a considerable large size and high cost is therefore avoided.

Besides, shutting down and rebooting a single CPE spends more than 10 seconds in the bisection method in the prior art, while the time needed for determining whether there is light leakage occurs at some laser device by the present invention is 5 to 10 seconds, and the time needed can be adjusted according to the requirements of the user or the accuracy. Therefore, the detecting device and the method provided by the present invention has an advantage of being able to real-time and high-speed detect the light leakage over the technique in the prior art. In addition, the bisection method in the prior art needs to be controlled from the system terminal. However, the present invention can perform the detection automatically, and optionally achieve the function of automatically resetting or rebooting when detecting an unusual condition by designing the firmware thereof in order to remove the software problems. In cooperation with the firmware designing or upgrading at the CO terminal, a function of the CPE automatically reporting back when the unusual condition occurring can be further implemented. Accordingly, the CO terminal knows which CPE the unusual condition occurs at, and notifies the engineers to solve the CPE hardware trouble.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A detecting device for a passive optical network (PON), comprising:
a laser device;
a detector coupled to the laser device and generating an output signal at one of a first level when the laser device emits light and a second level when the laser device does not emit light; and
a processor repeatedly detecting the output signal in a fixed period, and simultaneously counting a total number of changes that the output signal changes from the first level to the second level and the output signal changes from the second level to the first level so as to detect whether a light leakage occurs in the PON.

2. The detecting device as claimed in claim 1, wherein the processor detects if the level of the output signal is always kept at the first level in the fixed period and the total number of changes is zero in the fixed period.

3. The detecting device as claimed in claim 1, wherein the processor comprises:
an analog-to-digital converter (ADC) detecting the output signal; and
a timer counting the total number of changes.

4. The detecting device as claimed in claim 1, wherein the laser device is a bi-directional optical sub assembly (BOSA), the BOSA comprises a laser diode (LD) and a monitor photo diode (MPD), and the MPD is in one of two states of being conductive and being nonconductive corresponding to respectively when the LD emits light and when the LD does not emit light.

5. The detecting device as claimed in claim 4, wherein the detector comprises an operational amplifier having an inverting input terminal and a non-inverting input terminal, and coupled to the MPD, the inverting input terminal is coupled to the MPD through a first resistor and a second resistor, the non-inverting input terminal is coupled to the MPD through a third resistor, and is coupled to the inverting input terminal through a fourth resistor and a fifth resistor, and a node between the fourth and the fifth resistors receives a power supply voltage.

6. The detecting device as claimed in claim 5, wherein the second resistor has a resistance larger than that of the third resistor.

7. The detecting device as claimed in claim 5, wherein the fourth resistor has a resistance equal to that of the fifth resistor, and the operational amplifier further comprises an output terminal outputting the output signal, the output signal is at the first level under the condition that the MPD is on, and the output signal is at the second level under the condition that the MPD is off.

8. The detecting device as claimed in claim 4, wherein the detector comprises an operational amplifier and is coupled to the LD, wherein the operational amplifier has receiving a laser turn on voltage through a sixth resistor and connected a ground through a seventh resistor.

9. The detecting device as claimed in claim 8, wherein the operational amplifier further comprises an output terminal to output the output signal, the output signal is at the first level under the condition that the LD is on, and the output signal is at the second level under the condition that the LD is off.

10. A detecting method for a passive optical network (PON), comprising steps of:
providing a laser device;
generating an output signal at one of a first level when the laser device emits light and a second level when the laser device does not emit light; and
repeatedly detecting the output signal in a fixed period, and simultaneously counting a total number of changes that the output signal changes from one of the first level and the second level to the other one of the first level and the second level so as to detect whether a light leakage occurs in the PON.

11. The detecting method as claimed in claim 10, wherein the detecting step detects if the level of the output signal is always kept at the first level in the fixed period and the total number of changes is zero in the fixed period.

12. The detecting method as claimed in claim 10, wherein the repeatedly detecting step further comprises a step of using a processor to repeatedly detect the output signal, wherein the processor comprises:
an analog-to-digital converter (ADC) detecting the output signal; and
a timer counting the total number of changes.

13. The detecting method as claimed in claim 10, wherein the laser device is a bi-directional optical sub assembly (BOSA), the BOSA comprises a laser diode (LD) and a monitor photo diode (MPD), and the MPD is in one of two states of being conductive and being nonconductive corresponding to respectively when the LD emits light and when the LD does not emit light.

14. The detecting method as claimed in claim 13, wherein the generating step is performed by a detector, the detector comprises an operational amplifier having an inverting input terminal and a non-inverting input terminal, and coupled to the MPD, the inverting input terminal is coupled to the MPD through a first resistor and a second resistor, the non-inverting input terminal is coupled to the MPD through a third resistor, and is coupled to the inverting input terminal through a fourth resistor and a fifth resistor, and a node between the fourth and the fifth resistors receives a power supply voltage.

15. The detecting method as claimed in claim 14, wherein the second resistor has a resistance larger than that of the third resistor.

16. The detecting method as claimed in claim 14, wherein the fourth resistor has a resistance equal to that of the fifth resistor, and the operational amplifier further comprises an output terminal outputting the output signal, the output signal is at the first level under the condition that the MPD is on, and the output signal is at the second level under the condition that the MPD is off.

17. The detecting method as claimed in claim 13, wherein the generating step is performed by a detector, the detector comprises an operational amplifier and is coupled to the LD, wherein the operational amplifier has an inverting input terminal receiving a laser turn on voltage through a sixth resistor and connected a ground through a seventh resistor.

18. The detecting method as claimed in claim 17, wherein the operational amplifier further comprises an output terminal to output the output signal, the output signal is at the first level under the condition that the LD is on, and the output signal is at the second level under the condition that the LD is off.

19. A method for detecting a light leakage in a passive optical network (PON) having a light emitting state and a light non-emitting state, comprising steps of:
repeatedly detecting a plurality of signals transmitted in the PON in a period, wherein the plurality of signals are representative of the light emitting state and the light non-emitting state; and
if one of two statuses being that a light non-emitting state is detected and that there is a change occurred between the light emitting state and the light non-emitting state, determining that there is no light leakage.

20. The detecting method as claimed in claim 19 further comprising a step of: if the detected states are all light-emitting states and there is no change occurred between the light emitting state and the light non-emitting state, determining proving the light leakage is occurring.
